(19) United States
(12) Patent Application Publication
(10) Pub. No.: US 2018/0138578 A1
(43) Pub. Date: May 17, 2018

(54) WIRELESS COMMUNICATION DEVICE AND ANTENNA STRUCTURE

(71) Applicant: AUDEN TECHNO CORP., TAOYUAN COUNTY (TW)

(72) Inventor: CHI-MING CHIANG, Taoyuan County (TW)

(21) Appl. No.: 15/351,318

(22) Filed: Nov. 14, 2016

(51) Int. Cl. H01Q 1/24; H01Q 1/48; H01Q 5/392

(52) U.S. Cl. CPC H01Q 1/243; H01Q 5/392; H01Q 1/48

(57) ABSTRACT

A wireless communication device includes an electronic assembly and a rear cover fastened on the electronic assembly. A groove is recessed from an outer edge of a surrounding side plate of the rear cover. An antenna structure of the rear structure includes a dual-frequency antenna at least partially arranged on the surrounding side plate and arranged adjacent to the groove, a low-frequency selector and a high-frequency selector both connected to the dual-frequency antenna, and a switch connected between the high-frequency selector and the dual-frequency antenna. Each of the low-frequency selector and the high-frequency selector is configured to change a center frequency of the dual-frequency antenna by impedance matching. When the dual-frequency antenna is in a low-frequency mode, the switch is configured to open the connection between the high-frequency selector and the dual-frequency antenna for obstructing a parasitic capacitance effect generated from the high-frequency selector.

### BACKGROUND OF THE INVENTION

### 1. Field of the Invention

The instant invention relates to a communication device; in particular, to a wireless communication device and an antenna structure.

### 2. Description of Related Art

Due to advancement in science and technology, wireless communication devices have become miniaturized and lightweight, and the antenna structure must be able to operate in a plurality of communication frequency bands (e.g., a multi-band antenna structure). However, the multi-band antenna structure is more complicated than other kinds of antenna structures, and the multi-band antenna structure is required to be arranged in the limited space of the miniaturized wireless communication device, so there is a problem in the antenna industry about how to provide an antenna structure achieving the above conditions.

### SUMMARY OF THE INVENTION

The instant disclosure provides a wireless communication device and an antenna structure for effectively solving the problem generated from the conventional antenna structure.

The instant disclosure provides a wireless communication device, comprising: an electronic assembly including a frame, a displaying module installed on the frame, and a circuit board electrically connected to the displaying module; and a rear cover detachably fastened to the frame and covering the circuit board, the rear cover comprising: a rear plate and a surrounding side plate, wherein the surrounding side plate is connected to an edge of the rear plate and is detachably fastened to the frame, the surrounding side plate has a groove recessed from an outer edge thereof; and an antenna structure comprising: a grounding portion; a dual-frequency antenna at least partially arranged on the surrounding side plate, the dual-frequency antenna arranged adjacent to the groove and connected to the grounding portion, wherein the dual-frequency antenna includes a feeding point, a first contact, and a second contact, the first contact and the second contact are located at two opposite sides of the feeding point; the dual-frequency antenna is configured to be operated in a high-frequency mode or a low-frequency mode; a low-frequency selector and a high-frequency selector respectively and electrically connected to the first contact and the second contact and both electrically connected to the grounding portion, wherein the low-frequency selector is configured to impedance match the dual-frequency antenna for adjusting a center frequency of the low-frequency mode; the high-frequency selector is configured to impedance match the dual-frequency antenna for adjusting a center frequency of the high-frequency mode; and a switch arranged between and connected to the high-frequency selector and the dual-frequency antenna, wherein when the dual-frequency antenna is in the low-frequency mode, the switch is configured to open the electrical connection between the high-frequency selector and the dual-frequency antenna for obstructing a parasitic capacitance effect generated from the high-frequency selector.

The instant disclosure also provides an antenna structure, comprising: a grounding portion; a dual-frequency antenna at least partially arranged on the surrounding side plate, the dual-frequency antenna connected to the grounding portion, wherein the dual-frequency antenna includes a feeding point, a first contact, and a second contact, the first contact and the second contact are located at two opposite sides of the feeding point; the dual-frequency antenna is configured to be operated in a high-frequency mode or a low-frequency mode; a low-frequency selector and a high-frequency selector respectively and electrically connected to the first contact and the second contact and both electrically connected to the grounding portion, wherein the low-frequency selector is configured to impedance match the dual-frequency antenna for adjusting a center frequency of the low-frequency mode; the high-frequency selector is configured to impedance match the dual-frequency antenna for adjusting a center frequency of the high-frequency mode; and a switch arranged between and connected to the high-frequency selector and the dual-frequency antenna, wherein when the dual-frequency antenna is in the low-frequency mode, the switch is configured to open the electrical connection between the high-frequency selector and the dual-frequency antenna for obstructing a parasitic capacitance effect generated from the high-frequency selector.

In summary, when the dual-frequency antenna of the instant disclosure is in the low-frequency mode, the switch arranged between the high-frequency selector and the dual-frequency antenna is configured to open the electrical connection between the high-frequency selector and the dual-frequency antenna for obstructing the parasitic capacitance effect generated from the high-frequency selector, such that the wireless communication device (or the antenna structure) can solve the parasitic capacitance problem by setting the switch. Moreover, the size of the dual-frequency antenna of the instant disclosure can be reduced by connecting the dual-frequency antenna to the low-frequency selector and the high-frequency selector for adjusting the center frequency of the low-frequency mode and the center frequency of the high-frequency mode. In addition, at least part of the dual-frequency antenna in the instant disclosure is arranged on the surrounding side plate for effectively utilizing the rear cover, thereby reducing a space occupied by the antenna structure.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

FIG. 1 is a perspective view showing a wireless communication device according to the instant disclosure;

FIG. 2 is a perspective view showing the wireless communication device from another perspective;

FIG. 3 is an exploded view of FIG. 2;

FIG. 4 is a perspective view showing a rear cover of the wireless communication device;

FIG. 5 is a first schematic view showing an antenna structure of the wireless communication device;

FIG. 6 is a second schematic view showing the antenna structure of the wireless communication device;

FIG. 7 is a simulation diagram showing a low-frequency efficiency of the wireless communication device;

FIG. 8 is a simulation diagram showing a high-frequency efficiency of the wireless communication device; and

FIG. 9 is an exploded view showing the wireless communication device according to another embodiment of the instant disclosure.

### DETAILED DESCRIPTION OF THE PREFERRED EMBODIMENTS

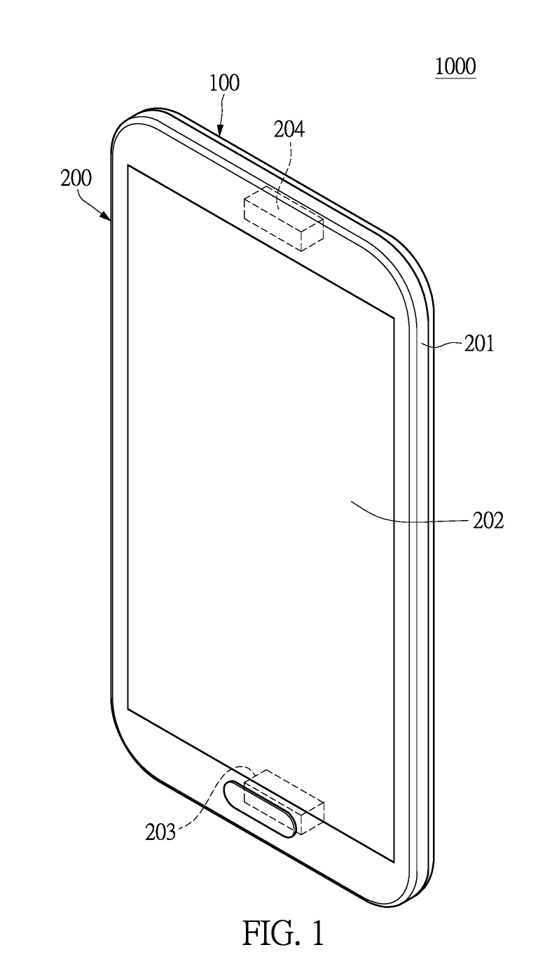

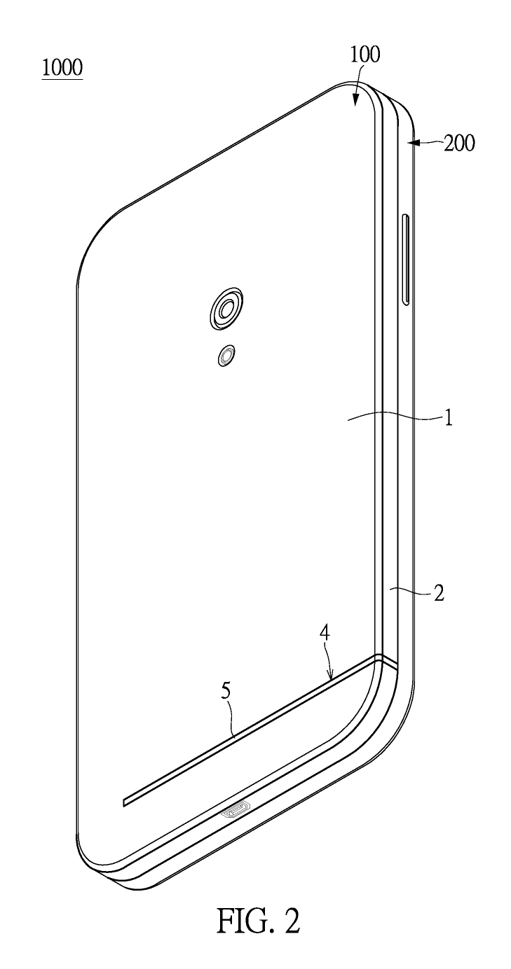

Please refer to FIGS. 1 through 8, which show an embodiment of the instant disclosure. References are hereunder made to the detailed descriptions and appended drawings in connection with the instant invention. However, the appended drawings are merely shown for exemplary purposes, rather than being used to restrict the scope of the instant invention.

Please refer to FIGS. 1 through 3, which show a wireless communication device 1000 of the instant disclosure, such as a notebook PC, a tablet PC, a GPS device, a handheld mobile device (e.g., smart phone), or a wearable device (e.g., smart watch). The wireless communication device 1000 in the instant embodiment is a smart phone for example. The wireless communication device 1000 includes an electronic assembly 200 and a rear cover 100 detachably fastened to the electronic assembly 200.

The electronic assembly 200 includes a frame 201, a displaying module 202 installed on the frame 201, a speaking module 203 and a listening module 204 both respectively arranged on two opposite sides of the frame 201, and a circuit board 205 disposed on a rear side of the displaying module 202. The circuit board 205 is electrically connected to the displaying module 202, the speaking module 203, and the listening module 204. It should be noted that the electronic assembly 200 further includes a battery module (not shown) and the other components.

Specifically, the frame 201 has a substantially rectangular-shaped edge and is preferably made of plastic. The frame 201 in the instant embodiment is configured to provide a supporting function, and the construction of the frame 201 is not limited to the figures. The circuit board 205 is mounted on the frame 201, and the electrical components of the electronic assembly 200 are electrically connected to the circuit board 205 directly or indirectly. For example, the electronic assembly 200 has a plurality of functional components (e.g., a connector, a camera, a flasher, and a switching key) mounted on the circuit board 205. The outer contour of the circuit board 205 is smaller than that of the frame 201. The speaking module 203 and the listening module 204 are respectively arranged adjacent to the bottom side and the top side of the frame 201.

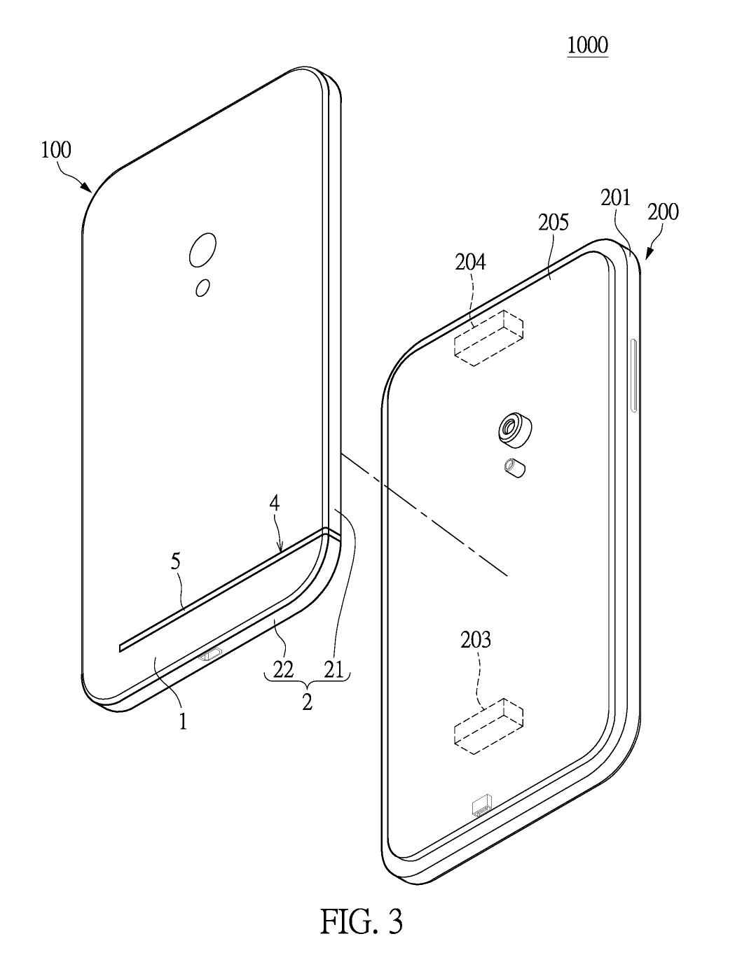

As shown in FIGS. 3 through 5, the rear cover 100 is detachably fastened to the frame 201 and covers the circuit board 205. The rear cover 100 includes a rear plate 1, a surrounding side plate 2, and an antenna structure 3. Part of the antenna structure 3 in the instant embodiment is integrated to the rear plate 1 and the surrounding side plate 2. That is to say, part of the rear plate 1 and part of the surrounding side plate 2 are used as the part of the antenna structure 3, thereby reducing a space occupied by the antenna structure 3, but the instant disclosure is not limited thereto.

The rear plate 1 has a substantially rectangular shape, and the surrounding side plate 2 is connected to an outer edge of the rear plate 1 and is detachably fastened to the frame 201. The surrounding side plate 2 has a groove 4 recessed from an outer edge thereof. The surrounding side plate 2 includes two long side segments 21, 21′ facing to each other and two short side segments 22, 22′ facing to each other. The short side plate 22 arranged adjacent to the speaking module 203 can be named as a bottom side segment 22, and the short side plate 22′ arranged adjacent to the listening module 204 can be named as a top side segment 22′. The groove 4 is recessed from an outer edge of one of the two long side segments 21, 21′ (i.e., the long side segment 21) to the rear plate 1, and the groove 4 is not formed on the other long side segment 21′.

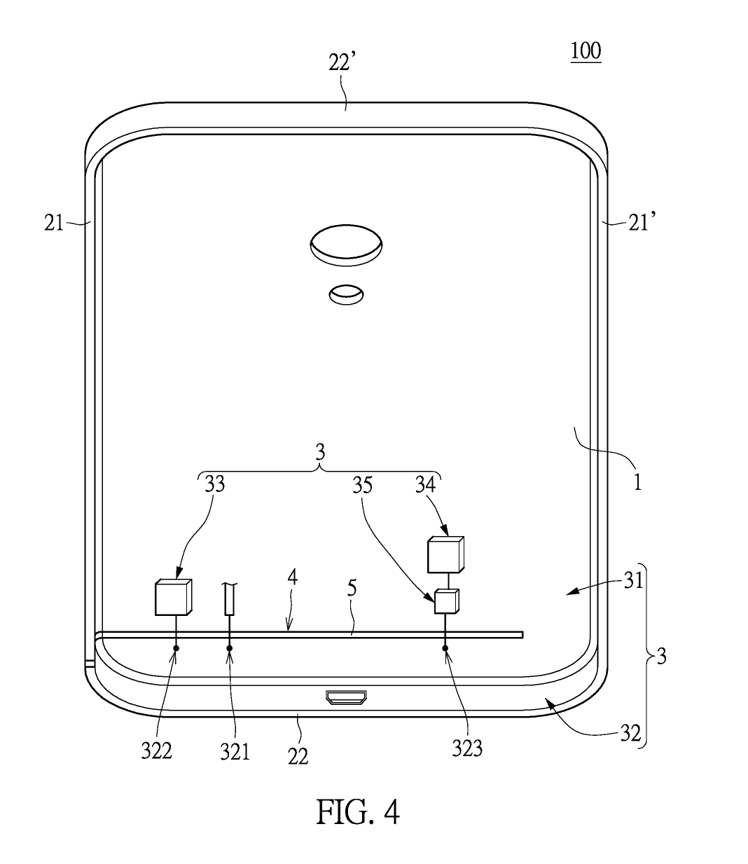

Specifically, the groove 4 in the instant embodiment is substantially parallel to each of the short side segments 21, 21′ and is arranged adjacent to one of the short side segments 21, 21′ (i.e., the bottom side segment 22). The rear cover 100 further includes an insulating body 5 covering or filled in the groove 4. The rear plate 1 and the surrounding side plate 2 in the instant embodiment are made of metal, and the rear plate 1 and the surrounding side plate 2 are divided into a bigger portion and a smaller portion by the groove 4 and a virtual line (not shown) extending from the groove 4. That is to say, as shown in FIG. 4, the bigger portion is arranged above the groove 4 and the virtual line, and the smaller portion is arranged under the groove 4 and the virtual line.

The antenna structure 3 includes a grounding portion 31, a dual-frequency antenna 32, a low-frequency selector 33, a high-frequency selector 34, and a switch 35. The dual-frequency antenna 32 is at least partially arranged on the surrounding side plate 2, and the dual-frequency antenna 32 is arranged adjacent to the groove 4 and is connected to the grounding portion 31. In the instant embodiment, the smaller portion is the dual-frequency antenna 32, and the bigger portion is the grounding portion 31. Moreover, when the rear cover 100 is fastened to the frame 201 of the electronic assembly 200, the antenna structure 3 is electrically connected to a signal feeding circuit (not shown) of the circuit board 205 by using a suitable manner. For example, an elastic sheet (not shown) can be used to contact the signal feeding circuit of the circuit board 205 and (a feeding point 321 of) the dual-frequency antenna 32 of the antenna structure 3.

The low-frequency selector 33 and the high-frequency selector 34 are disposed on the grounding portion 31. An end of the low-frequency selector 33 and an end of the high-frequency selector 34 are respectively and electrically connected to the dual-frequency antenna 32, and the other end of the low-frequency selector 33 and the other end of the high-frequency selector 34 are electrically connected to the grounding portion 31. The switch 35 is arranged between and connected to the high-frequency selector 34 and the dual-frequency antenna 32.

Thus, the parts of the antenna structure 3 (i.e., the grounding portion 31 and the dual-frequency antenna 32) in the instant embodiment are the rear plate 1 and the surrounding side plate 2 for effectively utilizing the rear cover 100, thereby reducing a space occupied by the antenna structure 3.

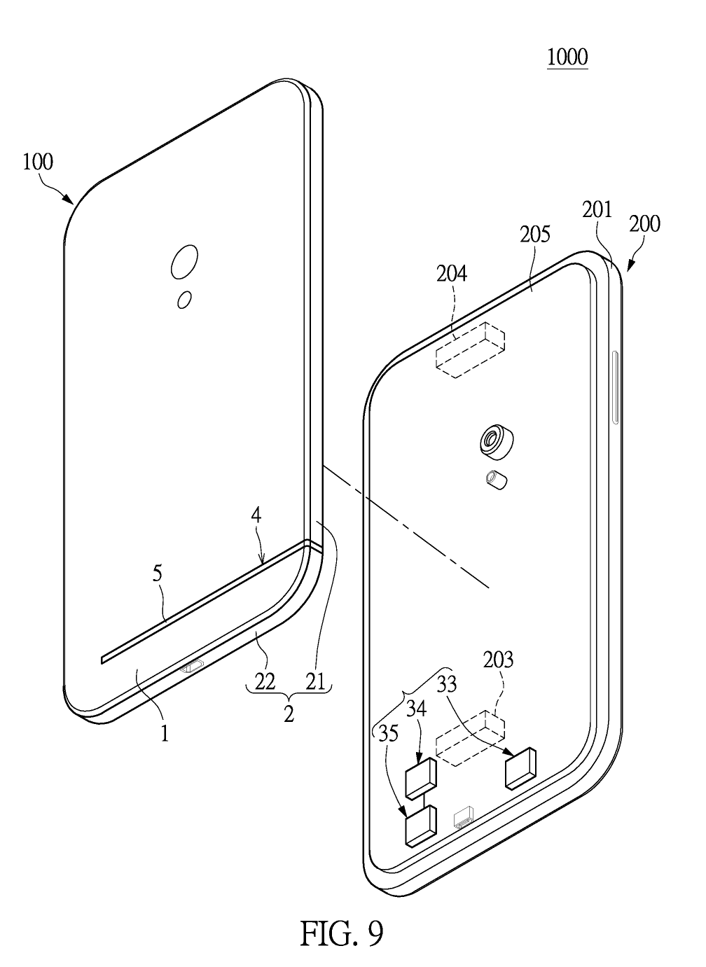

In addition, the antenna structure 3 can be adjusted according to a designer's demand, and the antenna structure 3 is not limited to the construction shown in FIG. 3. For example, as shown in FIG. 9, a grounding circuit (not shown) formed on the circuit board 205 can be defined as the grounding portion of the antenna structure, and the high-frequency selector 34 and the low-frequency selector 33 are mounted on the circuit board 205 and are electrically connected to the grounding circuit of the circuit board 205. The low-frequency selector 33 and the high-frequency selector 34 are respectively electrically connected to the antenna structure 3 by using an elastic member (not shown).

The following description discloses the construction and the operation of the antenna structure 3. Moreover, in a non-shown embodiment, the antenna structure 3 can be used without connecting the rear plate 1 and the surrounding side plate 2. In other words, the antenna structure 3 can be used with another component (not shown).

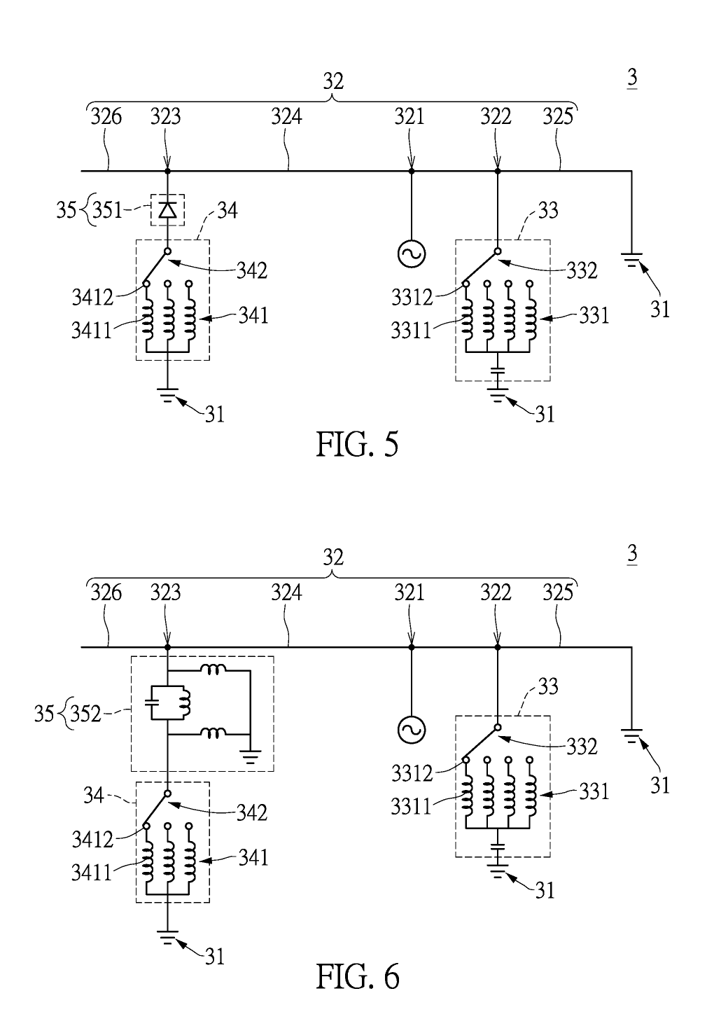

As shown in FIGS. 4 and 5, the dual-frequency antenna 32 is configured to be operated in a high-frequency mode or a low-frequency mode. The high-frequency mode means that the dual-frequency antenna 32 is operated in a high-frequency band of 1425 MHz˜2690 MHz, and the low-frequency mode means that the dual-frequency antenna 32 is operated in a low-frequency band of 698 MHz˜960 MHz, but the instant disclosure is not limited thereto.

The dual-frequency antenna 32 includes a feeding point 321, a first contact 322, and a second contact 323. The first contact 322 and the second contact 323 are located at two opposite sides of the feeding point 321, and a distance between the second contact 323 and the feeding point 321 in the instant embodiment is at least three times of a distance between the first contact 322 and the feeding point 321. Moreover, the dual-frequency antenna 32 includes a first antenna segment 324 arranged between the first contact 322 and the second contact 323, a second antenna segment 325 extended from the first contact 322 in a direction away from the feeding point 321, and a third antenna segment 326 extended from the second contact 323 in a direction away from the feeding point 321. The first antenna segment 324 and the third antenna segment 326 are arranged adjacent to the groove 4, and the second antenna segment 325 is integrally connected to the grounding portion 31 and is partially arranged adjacent to the groove 4.

The low-frequency selector 33 and the high-frequency selector 34 are respectively connected to the first contact 322 and the second contact 323 and are both connected to the grounding portion 31. In other words, the low-frequency selector 33 is arranged close to the feeding point 321 with respect to the high-frequency selector 34. Moreover, the low-frequency selector 33 is configured to impedance match the dual-frequency antenna 32 for adjusting a center frequency of the low-frequency mode, and the high-frequency selector 34 is configured to impedance match the dual-frequency antenna 32 for adjusting a center frequency of the high-frequency mode.

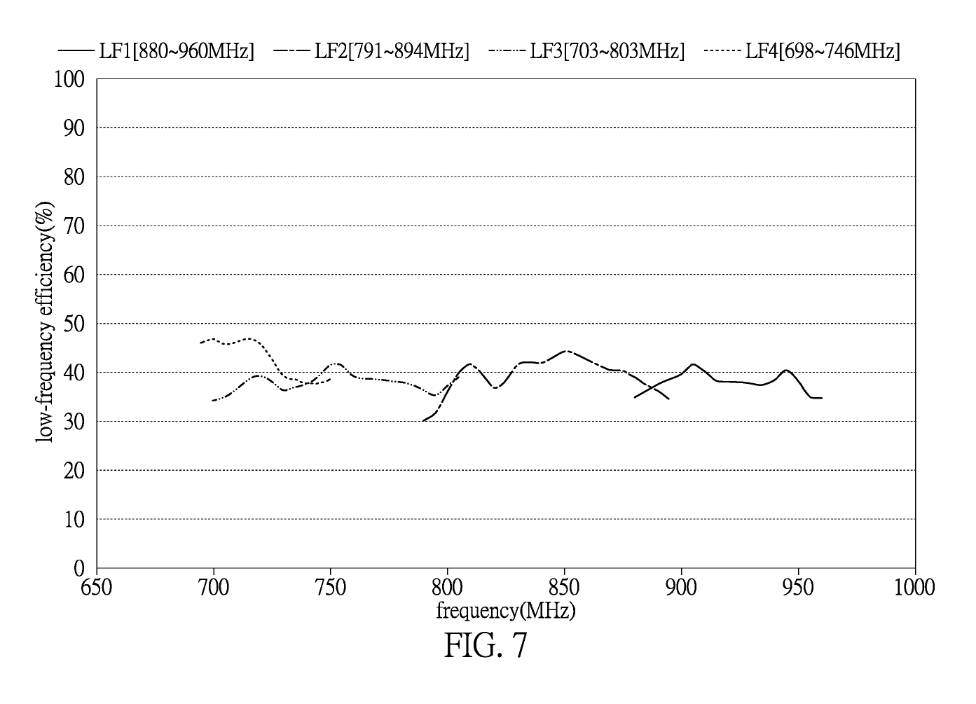

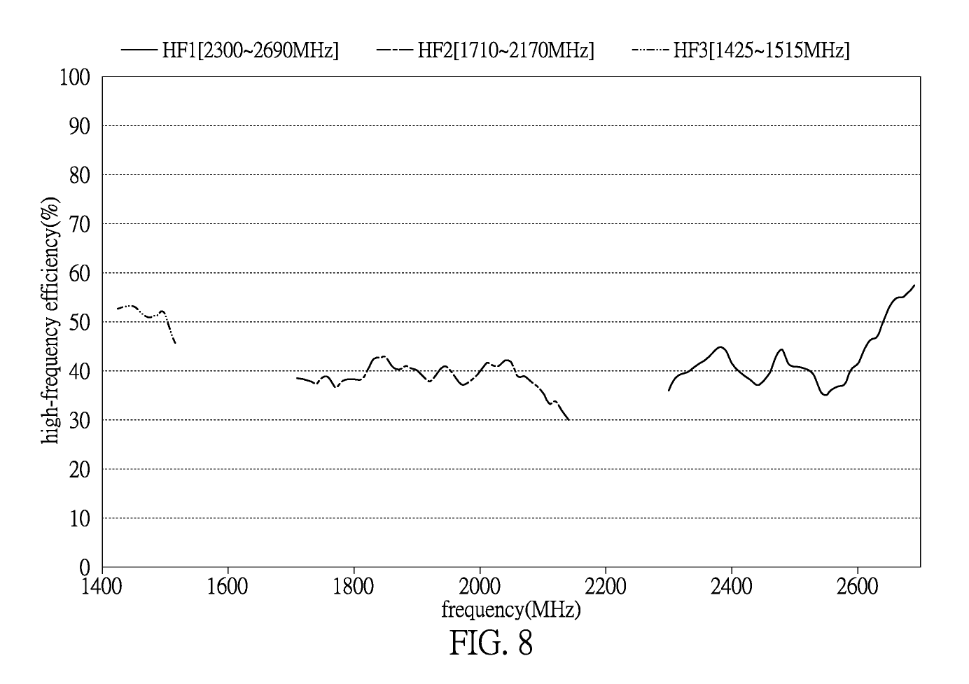

Specifically, the low-frequency selector 33 includes a low-frequency matching circuit 331 and a low-frequency selecting circuit 332. The low-frequency matching circuit 331 has a plurality of low-frequency subcircuits 3311. An end of each of the low-frequency subcircuits 3311 is electrically connected to the grounding portion 31, and the other end of each of the low-frequency subcircuits 3311 has a low-frequency contact 3312. The low-frequency selecting circuit 332 is electrically connected to the first contact 322 of the dual-frequency antenna 32. The low-frequency selecting circuit 332 is configured to selectively connect to at least one of the low-frequency contacts 3312 of the low-frequency subcircuits 3311, so that the at least one connected low-frequency subcircuit 3311 is impedance matched with the dual-frequency antenna 32 for adjusting the center frequency of the low-frequency mode. It should be noted that the center frequency of the low-frequency mode can be adjusted into different values (i.e., LF1˜LF4 shown in FIG. 7) by respectively impedance mating different low-frequency subcircuits 3311 with the dual-frequency antenna 32.

Moreover, the high-frequency selector 34 includes a high-frequency matching circuit 341 and a high-frequency selecting circuit 342. The high-frequency matching circuit 341 has a plurality of high-frequency subcircuits 3411. An end of each of the high-frequency subcircuits 3411 is electrically connected to the grounding portion 31, and the other end of each of the high-frequency subcircuits 3411 has a high-frequency contact 3412. The high-frequency selecting circuit 342 is electrically connected to the dual-frequency antenna 32 via the switch 35. The high-frequency selecting circuit 342 is configured to selectively connect to at least one of the high-frequency contacts 3412 of the high-frequency subcircuits 3411, so that the at least one connected high-frequency subcircuit 3411 is impedance matched with the dual-frequency antenna 32 for adjusting the center frequency of the high-frequency mode. The center frequency of the high-frequency mode can be adjusted into different values (i.e., HF1˜HF4 shown in FIG. 8) by respectively impedance mating different high-frequency subcircuits 3411 with the dual-frequency antenna 32.

In addition, the low-frequency selecting circuit 332 (or the high-frequency selecting circuit 342) shown in FIG. 5 or FIG. 6 is selectively connected to one of the low-frequency contacts 3312 (or one of the high-frequency contacts 3412), but the instant disclosure is not limited thereto. For example, the low-frequency selecting circuit 332 (or the high-frequency selecting circuit 342) can be provided with at least two switches (not shown) for respectively connecting to at least two of the low-frequency contacts 3312 (or at least two of the high-frequency contacts 3412).

Thus, the size of the dual-frequency antenna 32 of the instant embodiment can be reduced by connecting the dual-frequency antenna 32 to the low-frequency selector 33 and the high-frequency selector 34 for adjusting the center frequency of the low-frequency mode and the center frequency of the high-frequency mode.

However, when the dual-frequency antenna 32 is operated with the low-frequency selector 33, even if the high-frequency selecting circuit 342 is not connected to any high-frequency contact 3412, the high-frequency selector 34 still generates a parasitic capacitance effect to influence the operation of the dual-frequency antenna 32.

Accordingly, the switch 35 of the instant embodiment is arranged between and connected to the high-frequency selecting circuit 342 of the high-frequency selector 34 and the second contact 323 of the dual-frequency antenna 32. That is to say, when the dual-frequency antenna 32 is in the low-frequency mode, the switch 35 is configured to open the electrical connection between the high-frequency selector 34 and the dual-frequency antenna 32 for obstructing the parasitic capacitance effect generated from the high-frequency selector 34, such that the wireless communication device 1000 (or the antenna structure 100) can solve the parasitic capacitance problem by setting the switch 35.

Moreover, the switch 35 in the instant embodiment can be a P-intrinsic-N (PIN) diode 351 shown in FIG. 5, and the PIN diode 351 receives a bias voltage to construct an open loop when the dual-frequency antenna 32 is in the low-frequency mode. The switch 35 in the instant embodiment can also be a high-pass filter 352 shown in FIG. 6.

Therefore, the wireless communication device 1000 in the instant embodiment has a low-frequency efficiency of at least 30% (shown in FIG. 7) and a high-frequency efficiency of at least 30% (shown in FIG. 8) when the low-frequency selector 33 or the high-frequency selector 34 is used to adjust the center frequency, thereby achieving the efficiency requirement of the wireless communication device 1000.

The descriptions illustrated supra set forth simply the preferred embodiments of the instant invention; however, the characteristics of the instant invention are by no means restricted thereto. All changes, alterations, or modifications conveniently considered by those skilled in the art are deemed to be encompassed within the scope of the instant invention delineated by the following claims.

What is claimed is:

1. A wireless communication device, comprising:
an electronic assembly including a frame, a displaying module installed on the frame, and a circuit board electrically connected to the displaying module; and
a rear cover detachably fastened to the frame and covering the circuit board, the rear cover comprising:
a rear plate and a surrounding side plate, wherein the surrounding side plate is connected to an edge of the rear plate and is detachably fastened to the frame, the surrounding side plate has a groove recessed from an outer edge thereof; and
an antenna structure comprising:
a grounding portion;
a dual-frequency antenna at least partially arranged on the surrounding side plate, the dual-frequency antenna arranged adjacent to the groove and connected to the grounding portion, wherein the dual-frequency antenna includes a feeding point, a first contact, and a second contact, the first contact and the second contact are located at two opposite sides of the feeding point; the dual-frequency antenna is configured to be operated in a high-frequency mode or a low-frequency mode;
a low-frequency selector and a high-frequency selector respectively and electrically connected to the first contact and the second contact and both electrically connected to the grounding portion, wherein the low-frequency selector is configured to impedance match the dual-frequency antenna for adjusting a center frequency of the low-frequency mode; the high-frequency selector is configured to impedance match the dual-frequency antenna for adjusting a center frequency of the high-frequency mode; and
a switch arranged between and connected to the high-frequency selector and the dual-frequency antenna, wherein when the dual-frequency antenna is in the low-frequency mode, the switch is configured to open the electrical connection between the high-frequency selector and the dual-frequency antenna for obstructing a parasitic capacitance effect generated from the high-frequency selector.

2. The wireless communication device as claimed in claim 1, wherein the high-frequency selector includes:
a high-frequency matching circuit having a plurality of high-frequency subcircuits, wherein an end of each of the high-frequency subcircuits is electrically connected to the grounding portion, and the other end of each of the high-frequency subcircuits has a high-frequency contact; and
a high-frequency selecting circuit electrically connected to the dual-frequency antenna via the switch, wherein the high-frequency selecting circuit is configured to selectively connect to at least one of the high-frequency contacts of the high-frequency subcircuits, so that the at least one connected high-frequency subcircuit is impedance matched with the dual-frequency antenna for adjusting the center frequency of the high-frequency mode, wherein the center frequency of the high-frequency mode is adjustable into different values by respectively impedance mating different high-frequency subcircuits with the dual-frequency antenna.

3. The wireless communication device as claimed in claim 1, wherein the dual-frequency antenna includes a first antenna segment arranged between the first contact and the second contact, a second antenna segment extended from the first contact in a direction away from the feeding point, and a third antenna segment extended from the second contact in a direction away from the feeding point, wherein the second antenna segment is connected to the grounding portion.

4. The wireless communication device as claimed in claim 1, wherein a distance between the second contact and the feeding point is at least three times of a distance between the first contact and the feeding point.

5. The wireless communication device as claimed in claim 1, wherein the surrounding side plate includes two long side segments facing to each other and two short side segments facing to each other, the groove is recessed from an outer edge of one of the two long side segments to the rear plate, and the groove is not formed on the other long side segment.

6. The wireless communication device as claimed in claim 5, wherein the groove is substantially parallel to each of the two short side segments and is arranged adjacent to one of the two short side segments, the rear cover includes an insulating body filled in the groove.

7. The wireless communication device as claimed in claim 6, wherein the rear plate and the surrounding side plate are made of metal, and the rear plate and the surrounding side plate are divided into a bigger portion and a smaller portion by the groove and a virtual line extending from the groove, wherein the smaller portion is the dual-frequency antenna.

8. The wireless communication device as claimed in claim 7, wherein the bigger portion is the grounding portion.

9. The wireless communication device as claimed in claim 1, wherein the switch includes at least one of a P-intrinsic-N (PIN) diode and a high-pass filter.

10. An antenna structure, comprising:
a grounding portion;
a dual-frequency antenna at least partially arranged on the surrounding side plate, the dual-frequency antenna connected to the grounding portion, wherein the dual-frequency antenna includes a feeding point, a first contact, and a second contact, the first contact and the second contact are located at two opposite sides of the feeding point; the dual-frequency antenna is configured to be operated in a high-frequency mode or a low-frequency mode;
a low-frequency selector and a high-frequency selector respectively and electrically connected to the first contact and the second contact and both electrically connected to the grounding portion, wherein the low-frequency selector is configured to impedance match the dual-frequency antenna for adjusting a center frequency of the low-frequency mode; the high-frequency selector is configured to impedance match the dual-frequency antenna for adjusting a center frequency of the high-frequency mode; and
a switch arranged between and connected to the high-frequency selector and the dual-frequency antenna, wherein when the dual-frequency antenna is in the low-frequency mode, the switch is configured to open the electrical connection between the high-frequency selector and the dual-frequency antenna for obstructing a parasitic capacitance effect generated from the high-frequency selector.
